(19) United States
(12) Patent Application Publication
(10) Pub. No.: US 2018/0111847 A1
(43) Pub. Date: Apr. 26, 2018

(54) WATER PURIFICATION SYSTEM

(71) Applicant: InStill Water Tech Inc., Costa Mesa, CA (US)

(72) Inventor: Rahmi Oguz CAPAN, Mugla (TR)

(73) Assignee: InStill Water Tech Inc., Costa Mesa, CA (US)

(21) Appl. No.: 15/328,372

(22) PCT Filed: Jul. 8, 2015
(86) PCT No.: PCT/TR2015/000278

§ 371 Date: Jan. 23, 2017

(30) Foreign Application Priority Data
Jul. 24, 2014 (TR) 2014/08819

(51) Int. Cl. C02F 1/04; C02F 1/20; B01D 5/00; B01D 3/10

(52) U.S. Cl. CPC C02F 1/046; C02F 1/20; C02F 2103/08; B01D 3/10; C02F 2201/008; B01D 5/006

(57) ABSTRACT

With the present invention, a portable water purification system for purifying salt water is provided. The said water purification system comprises a water purification capsule which is leakproof and in which vacuum is generated an evaporation member provided in the water purification capsule; and at least one condensation member provided in the water treatment capsule and positioned on the evaporation member. Thanks to the fact that the condensation member is located on the evaporation member dimensions of the water purification system are reduced while operational efficiency of the water purification system is kept high.

### CROSS-REFERENCE TO RELATED APPLICATIONS

This application is a national phase filing under 35 USC § 371 of International Application No. PCT/TR2015/000278, filed Jul. 8, 2015, and which claims priority to Turkish Patent Application No. 2014/08819, filed on Jul. 24, 2014, the contents of which prior applications are incorporated herein by reference.

### FIELD OF THE INVENTION

The present invention relates to portable (mobile) water purification systems used for obtaining clean water with purification of salt water available in salt water resources such as sea, ocean, lake, etc. and industrial waste water.

### PRIOR ART

There is an increasing need for clean water (potable water) in the world. Although a great majority of our world is composed of water, sea and ocean water has a high salt content so such water resources cannot be used as potable water Therefore, it is of utmost importance to purify (desalination) sea and ocean water having a high content of salt in order to obtain clean water.

In the prior art, various applications are available for purifying water, especially salt water. One of the most efficient of these applications is the one disclosed in WO2007063395A2. In the said application, salt water is evaporated at a low temperature under vacuum conditions, and with condensation of the obtained steam in different medium, pure (or nearly pure) water is obtained. Then, a certain amount of salt is added to the obtained pure water so as to provide potable water.

In systems where water is evaporated under vacuum and then condensed, evaporation of water and condensation of steam are carried out in different columns (in an evaporation column and a condensation column, respectively). Therefore dimensions of the water purification facility are large in such applications, which necessitates that water purification facilities be established close to (or on) a water source such as sea or ocean. In addition, in these systems, the system must be located close to a heating source to be used for heating purposes.

### BRIEF DESCRIPTION OF THE INVENTION

With the present invention, a portable water purification system for purifying salt water is provided. The said water purification system comprises at least one water purification capsule which is leakproof and in which vacuum is generated; at least one salt water supply line that supplies salt water to be purified to the water purification capsule; at least one salt water inlet provided in the water purification capsule and transferring water received from the salt water supply line to the water purification capsule: at least one evaporation member provided in the water purification capsule and heating salt water transferred into the water purification capsule under vacuum so as to generate steam; at least one condensation member provided on the said evaporation member and condensing steam generated by the evaporation member so as to obtain clean water; at least one condensation pool interposed between the evaporation member and condensation member, and comprising at least one pool wall wherein clean water obtained in the condensation member is collected and at (east one opening for transferring steam generated by the evaporation member to the condensation member, at least one dean water outlet connected with the said pool wall and discharging clean water collected on the pool wall from the water purification capsule; at least one clean water transfer line wherein clean water received from the dean water outlet is transported; at least one salt collection chamber provided on the bottom of the water purification capsule, wherein water with a high salt concentration remaining after the evaporation of salt water is collected; at least one clean water container connected with the clean water transfer line, to which water received from the clean water transfer line is transferred and which is opened to the atmosphere so as to allow vacuum generation in tile water purification capsule; and at least cue frame holding the water purification capsule at a certain height so as to allow vacuum generation in the said water purification capsule.

in the water purification system according to the present invention thanks to the fact that the evaporation member and condensation member are located inside the same water purification capsule one above the other, dimensions of the water purification system are reduced while operational efficiency is kept high. With small dimensions of the water purification system, it can be transported easily and delivered to the required areas.

### OBJECT OF THE INVENTION

An object of the present invention is to provide a portable water purification system.

Another object of the present invention is to provide a water purification system with high productivity.

A further object of the present invention is to provide a water purification system which is cost-effective and easy to use,

### DESCRIPTION OF THE DRAWINGS

The exemplary embodiments of the water purification system according to the invention are illustrated in the enclosed drawings, in which:

FIG. 1 is a perspective view of a water purification system, seen in transportation stage.

FIG. 2 is a perspective view of a disassembled water purification system.

FIG. 3 is a perspective view of a water purification system in use.

FIG. 4 is a side sectional view of a water purification system in use.

FIG. 5 is a detailed view of a condensation pool provided in the water purification system.

All the parts illustrated in the drawing are individually assigned a reference numeral and the corresponding terms of these numbers are listed as follows.

| Water purification system | (S) |
|---|---|
| Water purification capsule | (1) |
| Condensation member | (2) |
| Evaporation member | (3) |
| Condensation heat exchanger | (4) |
| Evaporation heat exchanger | (5) |
| Coolant inlet | (6) |
| Coolant outlet | (7) |
| Heating fluid inlet | (8) |
| Heating fluid outlet | (9) |
| | 3 |
| Salt water supply line | (10) |
| Salt water inlet | (11) |
| Clean water outlet | (12) |
| Condensation pool | (13) |
| Pool wall | (14) |
| Opening | (15) |
| Clean water transfer line | (16) |
| Salt water container | (17a) |
| Highly salt water container | (17b) |
| Clean water container | (17c) |
| Salt collection chamber | (18) |
| Salt outlet | (19) |
| Salt transfer line | (20) |
| Injection member | (21) |
| Pre-heating pool | (22) |
| Pre-heating fluid inlet | (23) |
| Pre-heating fluid outlet | (24) |
| Pre-heater heat exchanger | (25) |
| Pre-heater inlet line | (26) |
| Pre-heater outlet line | (27) |
| Frame | (28) |

### DESCRIPTION OF THE INVENTION

In order to meet increasing need for clean water (potable water), see and ocean water (and other foreign substances) with a high salt content is desalinated. The said purification process is performed with evaporation of the water in salt water and condensation of steam, in order to increase evaporation rate of water, said evaporation process is carried out under vacuum. However, such systems operating under vacuum cannot be transported because of their large dimensions Therefore, with the present invention, a water purification system is provided which operates under vacuum and is portable.

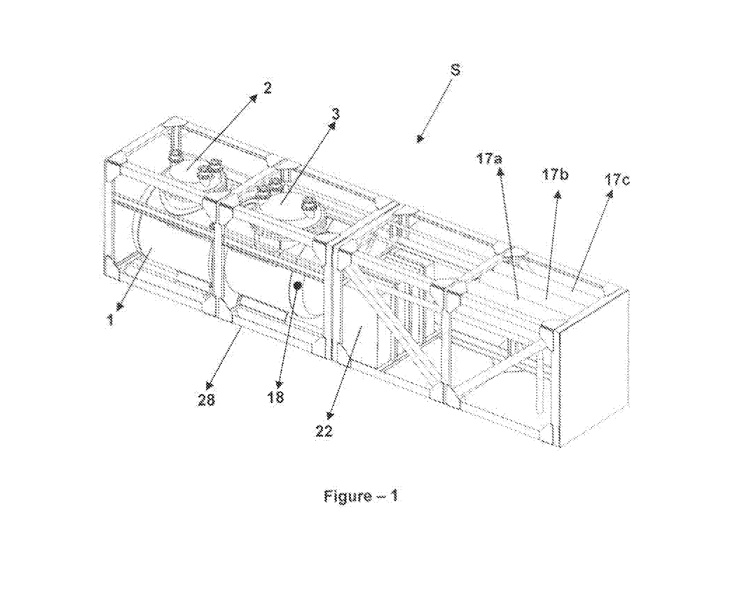

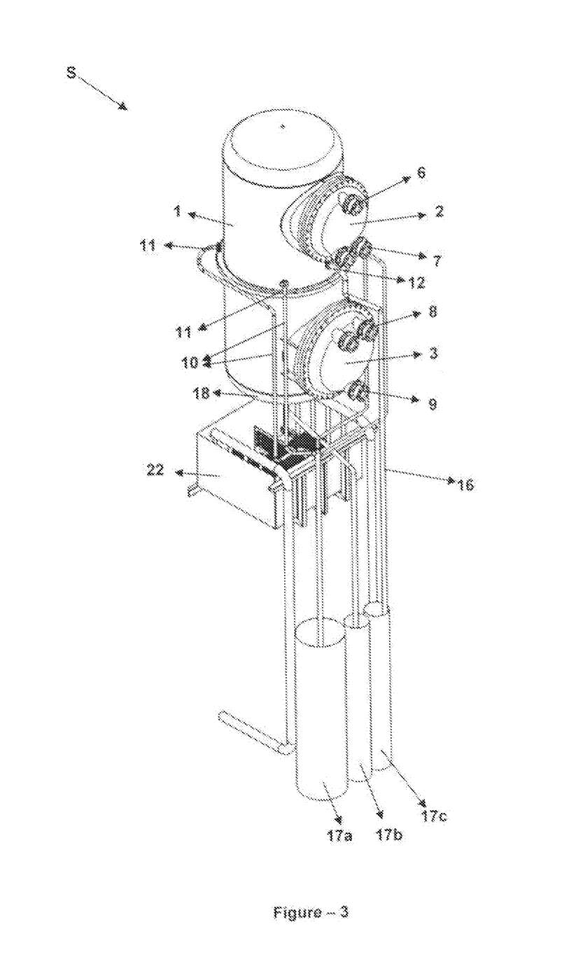

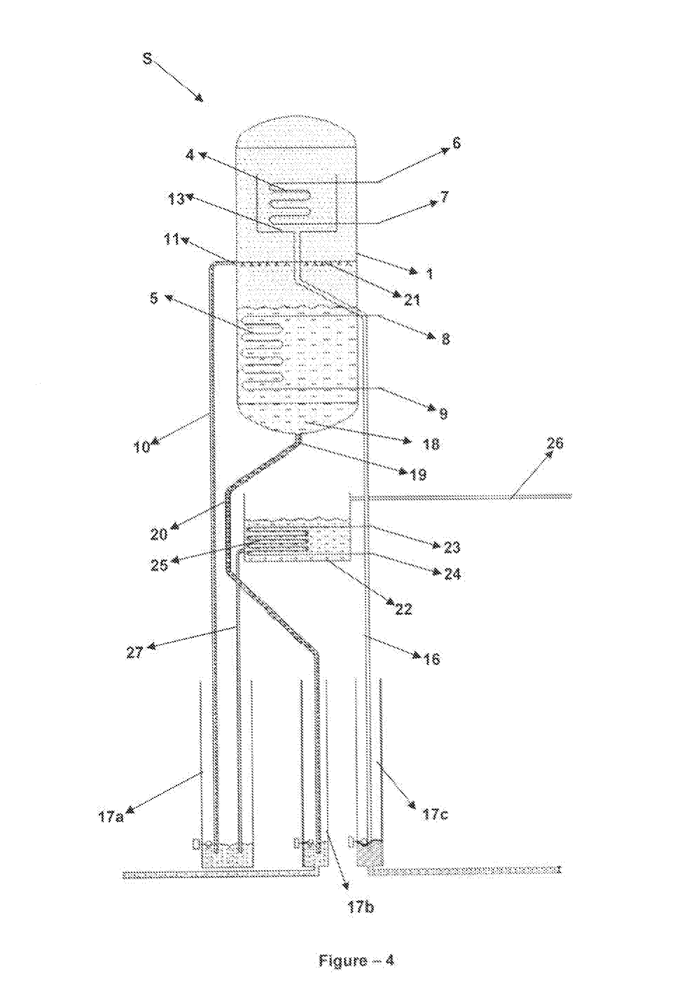

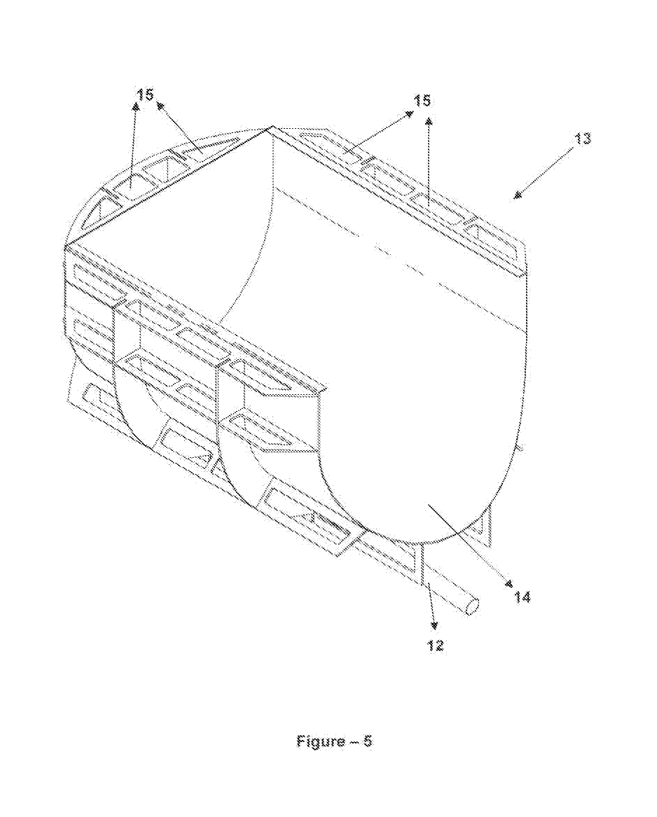

The inventive water purification system (S). as illustrated in FIGS. 1-5. comprises at least one water purification capsule (1) which is leakproof (air-proof) and in which vacuum is generated; at toast one salt water supply line (10) that supplies salt water to be purified to the water purification capsule (1), at least one salt water inlet (11) provided in the water purification capsule (1) and transferring water received from the salt water supply line (10) to the water purification capsule (1); at least one evaporation member (3) provided in the water purification capsule (1) and heating salt water transferred into the water purification capsule (1) under vacuum so as to generate steam: at least one condensation member (2) provided on the said evaporation member (3) and condensing steam generated by the evaporation member (3) so as to obtain clean water (pure or nearly pure water); at least one condensation pool (13) interposed between the evaporation member (3) and condensation member (2), and comprising at least one pool wall (14) wherein clean water obtained in the condensation member (2) is collected and at least one opening (15) for transferring steam generated by the evaporation member (3) to the condensation member (2); at least one clean water outlet (12) connected with the said pool wall (14) and discharging clean water collected on the pool wall (14) from the water purification capsule (1); at least one clean water transfer line (16) wherein clean water received from the clean water outlet (12) is transported; at least one salt collection chamber (18) provided on the bottom of the water purification capsule (1), wherein water with a high salt concentration (which is higher than that of salt water transferred into the water purification capsule (1)) remaining after the evaporation of salt water is collected; at toast one dean water container (17c) connected with the dean water transfer line (16), to which water received from the clean water transfer line (16) is transferred and which is opened to the atmosphere so as to allow vacuum generation in the water purification capsule (1); and at least one frame (28) holding the water purification capsule (1) at a certain height (for examples such that the salt water inlet (11) is at least 10.5 m higher than the level of salt water received) so as to allow vacuum generation in the said water purification capsule (1). The said salt water supply line (10) may directly open to a water source (i.e. sea, ocean, lake, etc.) or the water purification system (S) may comprise at least one salt water container (17a) connected with the salt water supply line (10), feeding salt water to the water supply line (10) and opened to the atmosphere (external environment) in order to generate vacuum in the water purification capsule (1). In the water purification system (S) according to the present invention, the condensation member (2) and evaporation member (3) are positioned in the same water purification capsule (1) one above the other, thereby enabling width and depth values of the water purification system (S) to be low. Thus, the water purification system (S) can be positioned horizontally, as shown in FIG. 1, so that it can be transported on a lorry or truck haulage (when being transported on a truck haulage, the frame (28) can be divided into several portions). Furthermore, since the condensation member (2) is located on the evaporation member (3), the evaporation surface is rendered as wide as possible so that the rate of evaporation is increased. As the operation speed of the water purification system (S) is directly related to the evaporation rate of water the water purification system (S) is allowed to operate with high productivity.

In a preferred embodiment of the invention, said salt collection chamber (18) is in the form of an external chamber that can be mounted to or released from the water purification capsule (1). In this embodiment, the salt collection chamber (18) can be released from the water purification capsule (1) at certain intervals so as to remove water accumulated inside the salt collection container (18) and having a high salt concentration from the water purification capsule (1). In an alternative embodiment, the salt collection chamber (18) is in the form of an integral chamber forming the bottom portion of the water purification capsule (1). In this embodiment, the water purification system (S) comprises at toast one salt outlet (19) discharging water collected Inside the salt collection chamber (18) arid having a high salt concentration from the water purification capsule (1); at least one salt transfer line (20) in which water received from the salt outlet (19) and having a high salt concentration is transported; and at (east one highly salt water container (17b) connected with the salt transfer line (20), wherein salt received from the salt transfer line (20) is collected and which is opened to the atmosphere so as to allow vacuum generation in the water purification capsule (1). Thus, water with a high salt concentration is removed from the water purification capsule (1) in an uninterrupted (continuous) manner during the evaporation process.

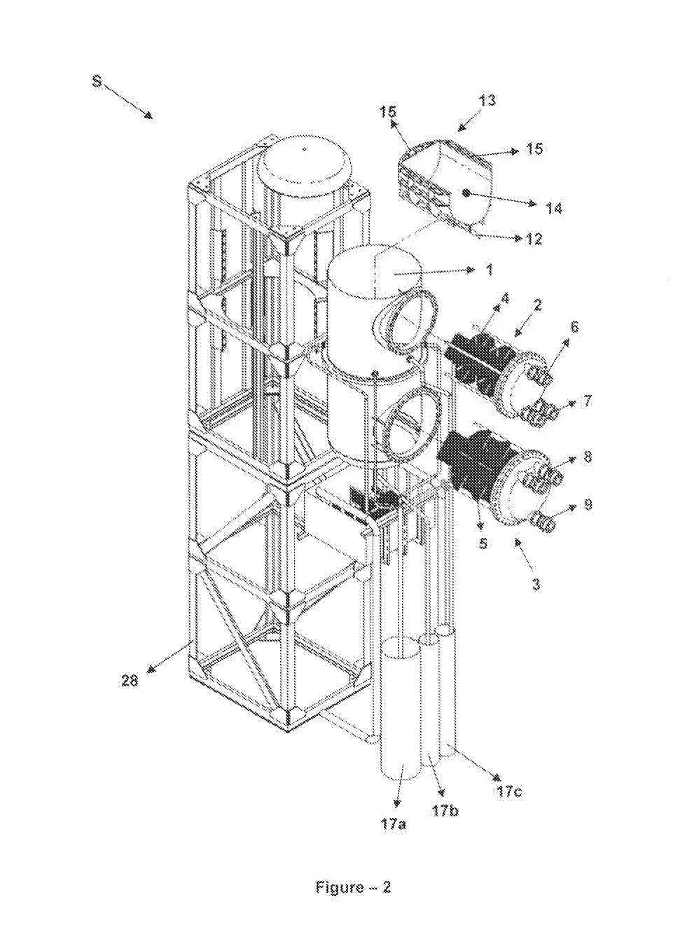

In an illustrative embodiment of the invention, the water purification system (S) is transported in an horizontal position, as shown in FIG. 1, to an area where a water purification process is to be realized (Ie. to a salt water source such as sea, lake<ocean. etc.). When the water purification system (S) is transported to the desired area, it is positioned vertically (operation position), as shown in FIGS. 2-4 When the water purification system (S) is placed vertically, the water purification capsule (1) is positioned at a certain height and the salt water container (17a), highly salt water container (I7b) and clean water container (17c) are opened to the atmosphere so that vacuumed medium is generated in the water purification capsule (1). In an illustrative embodiment, the salt water supply line (10), clean water transfer line (16) and salt transfer line (20) are closed and water is filled into the water purification capsule (1). While the water purification system (S) is in vertical position the salt water supply line (10), clean water transfer line (16) and salt transfer line (20) are opened to the salt water container (17a), clean water container (17c) and highly salt water container (17b), respectively. Thus, water level inside the water purification capsule (1) decreases such that atmosphere pressure imposed on the salt water container (17a), clean water container (17c) arid highly salt water container (17b) is balanced, thereby generating vacuum in the water purification capsule (1). Thanks to the vacuumed medium thus obtained, salt water is received from the salt water supply line (10) and transferred to the water purification capsule (1) through the salt water inlet (11) without using a pump. Also with the said vacuumed medium, salt water transferred to the water purification capsule (1) can be evaporated efficiently even at low temperatures (about 40-60° C.). Salt water inside the water purification capsule (1) is heated by the evaporation member (3) and vapor steam is generated. Steam thus obtained is passed through the opening (15) on the condensation pool (13) and reaches to the condensation member (2), wherein it is cooled down and condensed. The condensed water is collected on the pool wall (14), passed into the clean water transfer line (16) through the dean water outlet (12), and into the clean water container (17c). As long as salt water inside the water purification capsule (1) is evaporated, salt concentration of salt water increases. During evaporation, water with a high salt concentration is collected in the water collection chamber (18). Water collected in the salt collection chamber (18) and having a high salt concentration is passed through the salt outlet (13) and salt transfer line (20), respectively, and transferred to the highly salt water container (17b).

In a preferred embodiment of the invention, the said evaporation member (3) comprises at least one heating fluid Inlet (8) by means of which a heating fluid (i.e. hot water, steam etc.) is received; at least one evaporation heat exchanger (5) enabling heat exchange between the heating fluid received from the heating fluid inlet (8) and salt water inside the water purification capsule (1); and at least one heating fluid outlet (9) discharging the heating fluid which is in heat exchange relationship with said salt water from the evaporation member (3). The said evaporation member (3) is preferably configured to be mounted to and released from the water purification capsule (1). Thus, in order to clean the said evaporation heat exchanger (4), when necessary, the evaporation member (3) can be released from the water purification capsule (1).

In another preferred embodiment of the invention, the said condensation member (2) comprises at least one coolant inlet (6) by means of which a coolant (i.e. cold water such sea/ocean water etc.) is received; at least one condensation heat exchanger (4) enabling heat exchange between the coolant received from the coolant inlet (6) and steam inside the water purification capsule (1); and at least one coolant outlet (7) discharging the coolant which is in heat exchange relationship with said steam from the condensation member (2). The said condensation member (2) is preferably configured to be mounted to and released from the water purification capsule (1) Thus, in order to clean the said condensation heat exchanger (5), when necessary, the condensation member (2) can be released from the water purification capsule (1).

In another preferred embodiment of the invention, the said pool wail (14) is inclined so as to form both the bottom portion and side wails of the condensation pool (13). In this embodiment, the said opening (15) is located on the circumference of the pool wall (14). Thus, steam passing through the opening (15) and clean water collected on the pool wail are prevented to intervene to each other.

In a preferred embodiment of the invention, the water purification system (S) comprises at least one Injection member (21) provided in the said water purification capsule (1), connected with the said salt water inlet (11) and injecting salt water received from the salt water inlet (11) Into the water purification capsule (1). With the said injection member (21), salt water is transferred into the water purification capsule (1) in a granulated form. Thus, evaporation process is rendered faster so that the water purification system (S) operates more efficiently. The said injection member (21) is preferably interposed between the condensation member (2) and the evaporation member (3). Thus, salt water injected into the water purification capsule (1) from the injection member (21) is prevented from being mixed into dean water obtained in the condensation member (2).

In art illustrative embodiment of the invention, the said frame (28) is located on the outer side of the water purification system (S) (so as to partially surround the remaining members). In this embodiment, the said frame (28) can be connected to a truck or a lorry. In another preferred embodiment, the said frame (28) comprises at least two movement members (i.e. wheels). In this embodiment, the frame (28) can be directly connected to a lorry or a truck like haulage.

In another preferred embodiment of the invention, the said water purification system (S) comprises at least one pre-heating pool (22) wherein salt water is heated and degasified before being transferred to the water purification capsule (1). The said pre-heating pool (22) comprises at least one pre-heater inlet line (26) by means of which salt water is received from a source (such as sea. lake or waste water source); at least one pre-heater heat exchanger (25) that heats salt water received from the pre-heater inlet tine (26); and at least one pre-heater outlet line (27) transferring heated salt water into the salt water container (17a) to be transferred into file water purification capsule (1), Here, gasses dissolved in salt water upon heating thereof are separated from salt water and released to the atmosphere. The said pre-heating pool (22) also comprises at least one pre-heating fluid inlet (23) that transfers a hot fluid into the pre-heater heat exchanger (25) and at least one pre-heating fluid outlet that transfers heat of the said Hot fluid to salt water by means of tie pre-heater heat exchanger (2$) and then discharges the coded fluid from the heating pool (22).

In an illustrative embodiment of the invention, dimensions of the water purification system (S) are 2.44 m×2.77 m'12.2 m. In this embodiment, the water purification system (S) may be positioned horizontally, as shown in FIG. 1, and be transported easily In this embodiment, a water purification system (S) can produce 100 tons of dean water per day. Here, the amount of clean water produced may vary depending on the heat and amount of the heating fluid used.

In the water treatment system (S) according to the present invention, thanks to the fact mat the evaporation member (3) and condensation member (2) are located inside the same water treatment capsule one above the other, dimensions of the water treatment system am reduced while operational efficiency Is kept high. With small dimensions of the water treatment system (S), it can be transported and delivered to the required areas in an easy manner.

1-16. (canceled)

17. A portable water purification system comprising:
a frame surrounding a water purification capsule, the water purification capsule comprising:
an evaporation member which generates steam by heating water to be purified under a vacuum; and
a condensation member which condenses the steam generated by the evaporation member.

18. The system of claim 17, wherein the frame surrounds a water to be purified supply line, a water to be purified inlet configured to transfer water from the water to be purified supply line to the water purification capsule, a condensation pool configured to collect water from the condensation member, a clean water outlet configured to transfer water from the condensation pool to a clean water transfer line, an impurity collection chamber, and a clean water container configured to collect water from the clean water transfer line.

19. The system of claim 17, wherein the frame is configured to be moveable by a vehicle for transportation of the portable water purification system.

20. The system of claim 17, wherein the frame comprises a plurality of wheels and is configured to be moveable by a vehicle to transport the portable water purification system.

21. The system of claim 17, wherein the portable water purification system is configured to operate in a vertical orientation and be transported in a horizontal orientation.

22. The system of claim 17, wherein the frame is configured to separate into two or more portions.

23. The system of claim 17, wherein the water purification capsule comprises an impurity collection chamber.

24. The system of claim 23, wherein one or more of the condensation member, the evaporation member, and the impurity collection chamber is configured to release from the water purification capsule.

25. The system of claim 17, comprising one or more injection members configured to inject water to be purified from a water to be purified inlet into the water purification capsule.

26. The system of claim 25, wherein the injection member is interposed between the condensation member and the evaporation member.

27. The system of claim 17, wherein the frame holds the water purification capsule at a height sufficient to generate a vacuum in the water purification capsule during operation of the portable water purification system.

28. The system of claim 17, comprising a water to be purified inlet configured to transfer water from a water to be purified supply line to the water purification capsule, wherein the frame is configured to hold the water purification capsule so that the water to be purified inlet is at least 10.5 m higher than a level of water to be purified received by the portable water purification system.

29. The system of claim 17, comprising a pre-heating pool which is configured to heat the water to be purified to remove gasses dissolved in the water to be purified.

30. The system of claim 17, wherein the water to be purified is saltwater.

31. A portable water purification system comprising:
an evaporation member configured to generate steam by heating water to be purified in a vacuum environment; and
a condensation member positioned on top of the evaporation member configured to condense steam generated by the evaporation member; and
a frame surrounding the condensation member and the evaporation member.

32. The system of claim 31, wherein the frame is configured to be moveable by a vehicle for transportation of the portable water purification system.

33. The system of claim 31, wherein the frame comprises a plurality of wheels and is configured to be moveable by a vehicle to transport the portable water purification system.

34. The system of claim 31, wherein the portable water purification system is configured to operate in a vertical orientation and be transported in a horizontal orientation.

35. The system of claim 31, wherein the frame is configured to separate into two or more portions.

36. The system of claim 31, comprising an impurity collection chamber.

37. The system of claim 36, wherein the impurity collection chamber is located below the condensation member and the evaporation member.

38. The system of claim 31, comprising a pre-heating pool which is configured to heat the water to be purified to remove gasses dissolved in the water to be purified.

39. The system of claim 31, wherein the water to be purified is saltwater.

40. A portable water purification system comprising:
a frame surrounding a condensation member and an evaporation member;
a condensation pool having a bottom and a plurality of side walls, wherein the condensation pool is interposed between the condensation member and the evaporation member;
an inclined pool wall that forms the bottom and one or more of the plurality of side walls of the condensation pool; and
wherein the purification system is configured so that during operation, steam from the evaporation member condenses on the condensation member and collects on the inclined pool wall of the condensation pool of the portable water purification system.

41. The system of claim 40, wherein the frame is configured to be moveable by a vehicle for transportation of the portable water purification system.

42. The system of claim 40, wherein the frame comprises a plurality of wheels and is configured to be moveable by a vehicle to transport the portable water purification system.

43. The system of claim 40, wherein the portable water purification system is configured to operate in a vertical orientation and be transported in a horizontal orientation.

44. The system of claim 40, wherein the frame is configured to separate into two or more portions.

45. The system of claim 40, wherein the system is configured so that steam from the evaporation member does not come into contact with the condensed water collected on the inclined pool wall during operation.

46. The system of claim 40, comprising a pre-heating pool which is configured to heat the water to be purified to remove gasses dissolved in the water to be purified.

47. The system of claim 40, wherein the water to be purified is saltwater.
